(19) United States
(12) Patent Application Publication
(10) Pub. No.: US 2008/0035424 A1
(43) Pub. Date: Feb. 14, 2008

(54) Portable stair platform

(76) Inventor: Alan Klockler, Massapequa, NY (US)

Correspondence Address: HARSHAW RESEARCH, INC., 210 W. TECUMSEH STREET, OTTAWA, KS, 66067, US

(21) Appl. No.: 11/503,735

(22) Filed: Aug. 14, 2006

(51) Int. Cl. E06C 7/42; E06C 7/16

(52) U.S. Cl. 182/116; 182/107

(57) ABSTRACT

A portable stair platform includes a planar member (i.e. a platform) having opposed sides and opposed ends. A first set of legs extends from a first end of the planar member and is movable between a first configuration generally perpendicular to the planar member (use configuration) and a second position generally parallel thereto (collapsed configuration). A second set of legs extends from an opposed end of the planar member. At least one set of legs is height adjustable. A wheel may be coupled to the planar member for easy transport of the device. The planar member includes a peripheral lip for holding items thereon. The stair platform may also include an extensible handle for operating the platform as a hand truck.

### BACKGROUND OF THE INVENTION

This invention relates generally to ladder accessories and, more particularly, to a portable stair platform that enables a user to safely place and use a ladder on stairs.

Painters routinely need to paint the walls and ceilings surrounding and above staircases. These areas, however, are the most difficult to access in that there is no safe and convenient way to place and use a ladder on the stairs due to the different elevations of the stairs and the otherwise equal-length legs of the ladder. Frequently, this situation leads to worker injury when ladders are placed at odd and uneven configurations on the stairs and the painter must stretch into dangerous positions.

Various devices have been proposed in the art for leveling the legs of a ladder or providing a platform on which to position a ladder. Scaffolding, of course, is well known for providing elevated work space. While assumably effective for their intended purposes, the existing devices are relatively complicated to use. Further, existing devices are not easily portable or storable when not in use.

Therefore, it would be desirable to have a portable stair platform enabling a ladder to be securely positioned atop a set of stairs for safely and conveniently accessing the surrounding walls and ceiling. Further, it would be desirable to have a stair platform that may be easily and quickly moved between collapsed/storage and use configurations. In addition, it would be desirable to have a stair platform that is adjustable to present a level surface even if the stairs themselves are not level.

### SUMMARY OF THE INVENTION

A portable stair platform according to the present invention includes a generally planar member having opposed first and second sides and opposed first and second ends. The platform also includes first and second sets of legs. The first set of legs extends from the first end of the planar member and is movable from a first position generally perpendicular to the planar member (a use configuration) and a second position generally parallel to the planar member (a storage or transport configuration). The second set of legs extends from the second end of the planar member and at least one of the first or second set of legs is height adjustable.

A wheel may be coupled to the planar member such that the planar member may be transported by rolling it on the wheel when the first set of legs is in the second position. The planar member may also include a lip extending along the first end so as to retain objects on the upper surface when the first set of legs are at the first position or to support objects when the first set of legs is at the second position.

Therefore, a general object of this invention is to provide a portable stair platform for supporting a ladder in a level position upon stairs.

Another object of this invention is to provide a portable stair platform, as aforesaid, having a set of legs easily movable between extended and collapsed configurations such that the platform may be selectively stored or used.

Still another object of this invention is to provide a portable stair platform, as aforesaid, that may be easily moved between locations on a wheel.

Yet another object of this invention is to provide a portable stair platform, as aforesaid, having a set of legs that is height adjustable so as to maintain a level surface even if the stairs themselves are not level.

A further object of this invention is to provide a portable stair platform, as aforesaid, in which an upper surface includes a lip for maintaining objects thereon.

A still further object of this invention is to provide a portable stair platform, as aforesaid, that is economical to manufacture and user-friendly to operate.

Other objects and advantages of the present invention will become apparent from the following description taken in connection with the accompanying drawings, wherein is set forth by way of illustration and example, embodiments of this invention

### BRIEF DESCRIPTION OF THE DRAWINGS

FIG. 1 is a perspective view of a stair platform according to a preferred embodiment of the present invention in use on stairs;

FIG. 2 is a perspective view of the stair platform as in FIG. 1 removed from the staircase and with the first set of legs in an extended configuration;;

FIG. 3 is a perspective view of the stair platform as in FIG. 2 with the first set of legs in a collapsed configuration;

FIG. 4A is side view of the stair platform as in FIG. 1 illustrating a first set of legs in one height extended configuration;

FIG. 4B is a side view of the stair platform as in FIG. 1 illustrating a first set of legs in another height extended configuration;

FIG. 5A is a perspective view of a stair platform according to another embodiment of the present invention, the stair platform being illustrated in a collapsed configuration;

FIG. 5B is an isolated view on an enlarged scale taken from FIG. 5A; and

FIG. 6 is a perspective view of the stair platform as in FIG. 5A illustrated in a use as a hand truck.

### DESCRIPTION OF THE PREFERRED EMBODIMENT

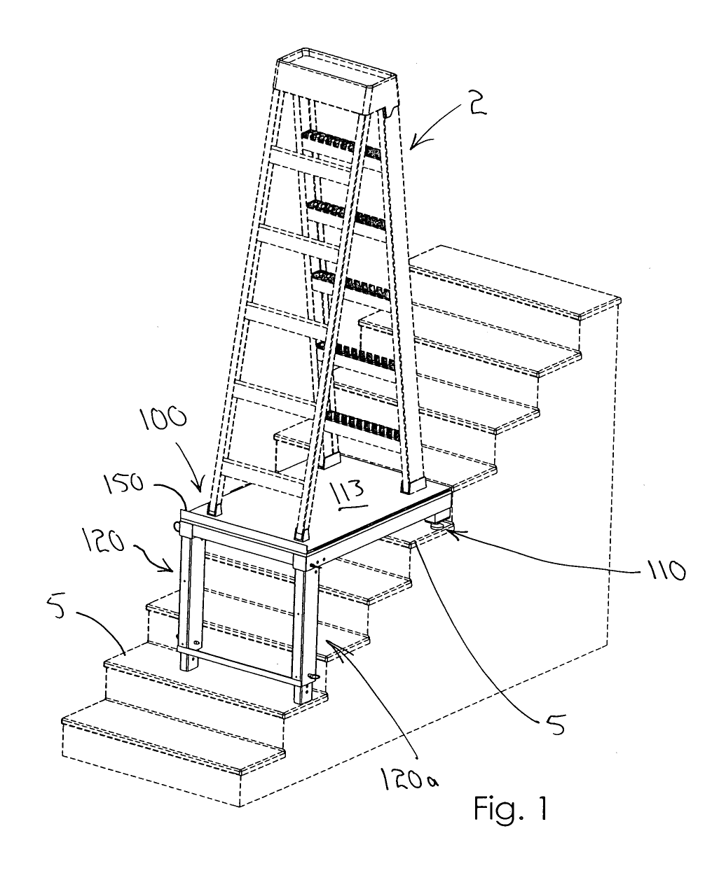

A portable stair platform 100 according to the present invention will now be described in detail with reference to FIGS. 1 through 6 of the accompanying drawings. More particularly, a portable stair platform 100 according to the current invention includes a primary member 110 (also referred to herein as a generally planar member).

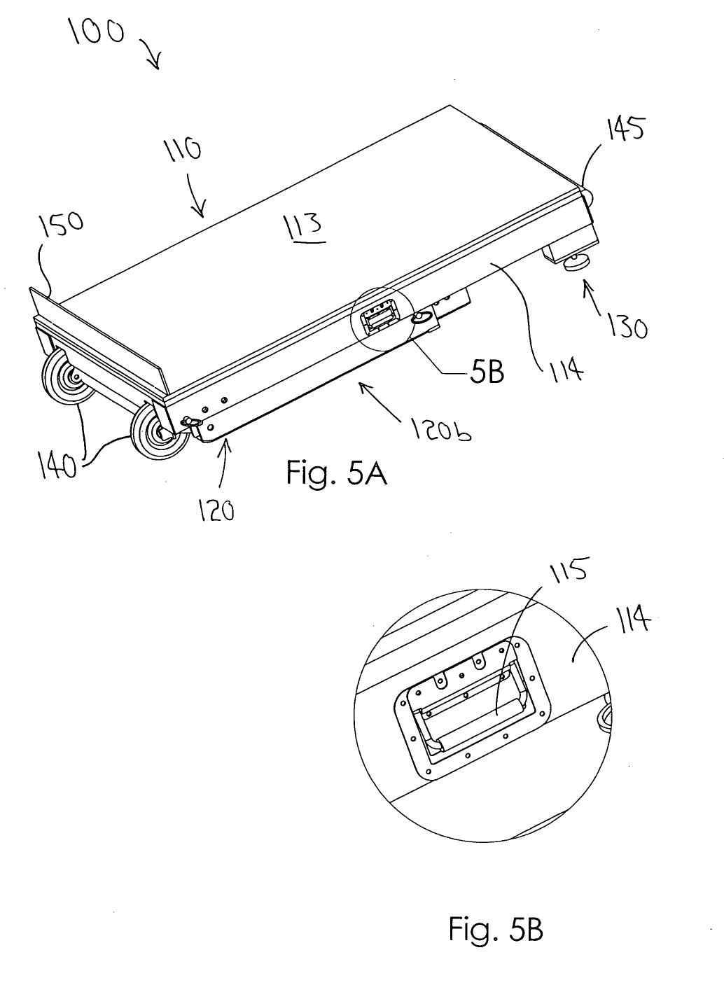

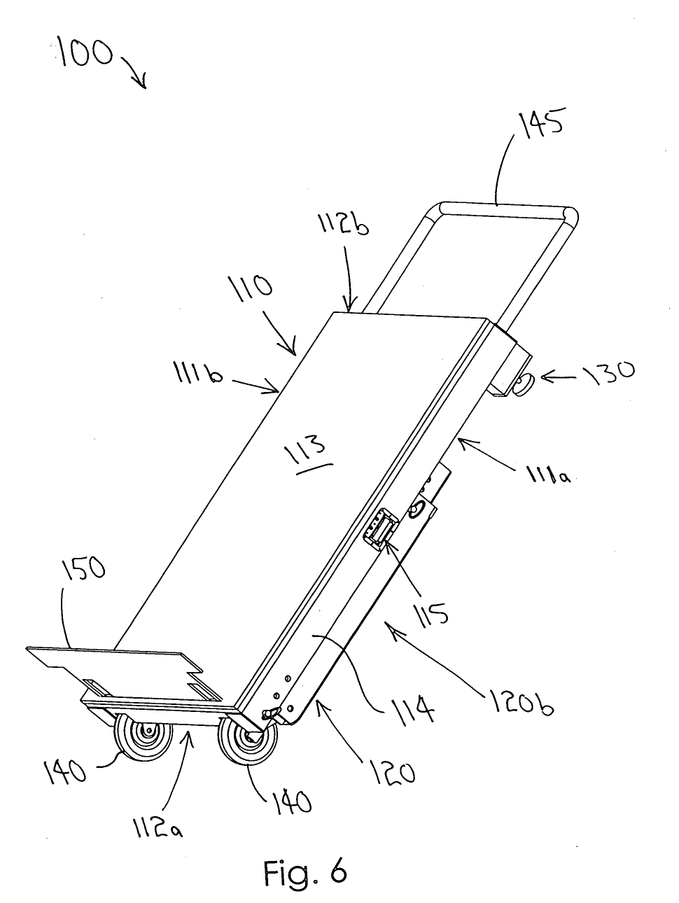

The primary member 110 includes opposed first and second sides 111a, 111b, opposed first and second ends 112a, 112b, and a generally planar upper surface 113 (also referred to herein as a top portion). A plurality of siderails 114 may support the top portion 113, and additional supports (not shown) may span the siderails 114 to brace the top portion 113. The top portion 113 may include a rubberized material to prevent objects (e.g., ladder 2 shown in FIG. 1) from sliding along the primary member 110. The generally planar upper surface 113 may include plywood and the siderails 114 may be constructed of aluminum channel to keep the weight of the portable stair platform 100 low while providing sufficient material strength and considering cost factors. It should be understood that alternate or additional materials may be used, however. As shown in FIG. 5a through FIG. 6, at least one siderail 114 may include an extendable handle 115.

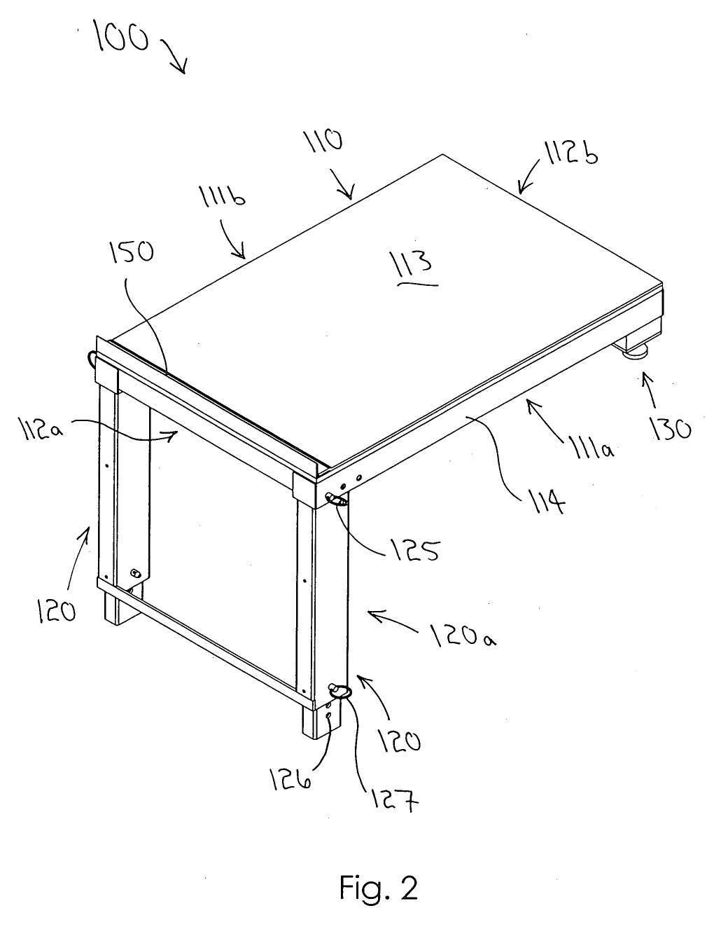

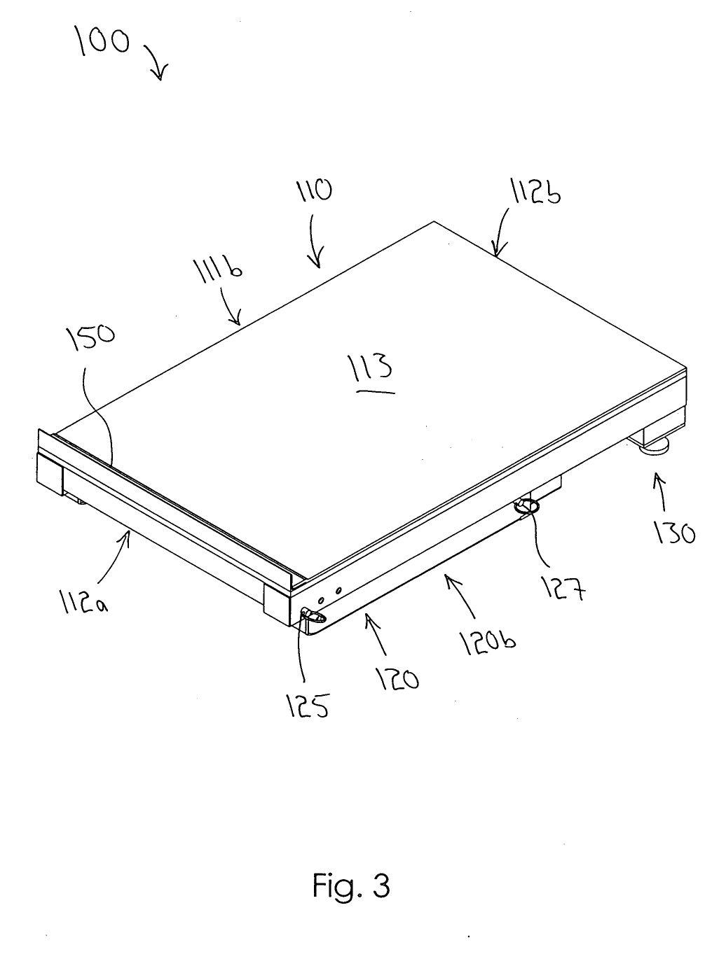

A first set of legs 120 extends from the first end 112a of the primary member 110. As shown throughout the drawings, one leg 120 may be adjacent the first side 111a of the primary member 110, and another leg 120 may be adjacent the second side 111b of the primary member 110. The first set of legs 120 is movable between a first position 120a generally perpendicular to the top portion 113 of the planar member 110 (FIGS. 1 and 2) and a second position 120b generally parallel to the top portion 113 of the planar member 110 (FIG. 3). A pin 125 may selectively maintain the first set of legs 120 at the first and second positions 120a, 120b, such as by passing through holes in the primary member 110 and a respective leg 120 or by being fixed to the primary member 110 and passing through a hole in a respective leg 120. The pin 125 may be spring-loaded to bias the pin 125 in a manner that imparts a locking effect, or the pin 125 may be otherwise secured so that the pin 125 is not accidentally removed.

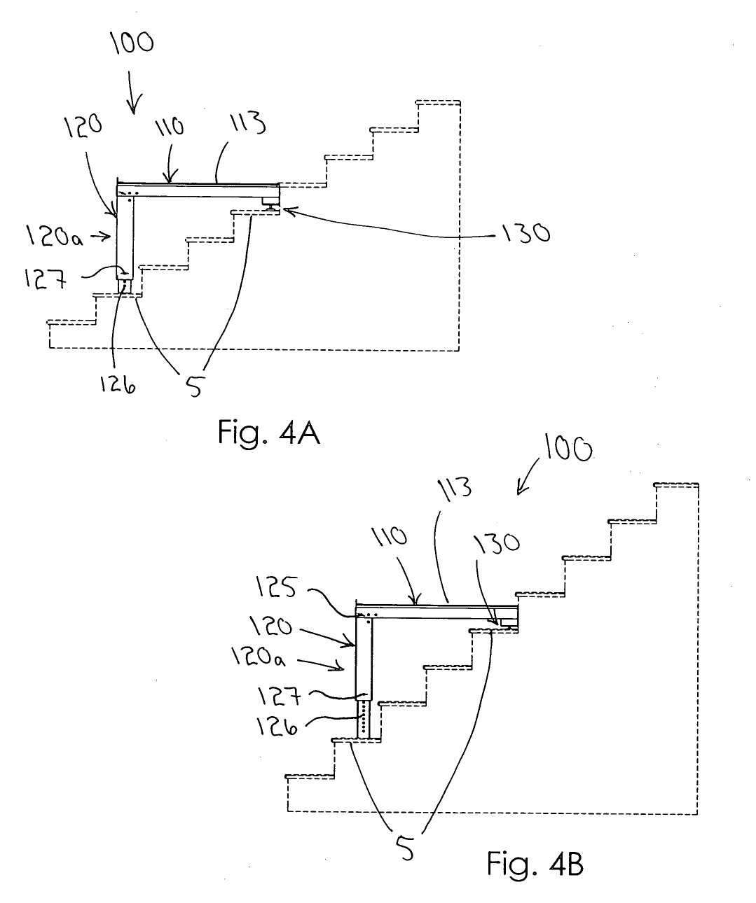

The legs 120 may be height-adjustable, and as shown in FIGS. 2, 4A, and 4B, the legs 120 may be telescoping legs having predetermined increments of adjustability. In other words, a telescoping portion of each legs 120 may have holes 126 spaced apart a predetermined distance from one another, and a pin 127 may pass through a hole 126 to maintain the selected length of the leg 120. The legs 120 may be constructed of aluminum channel to keep the weight of the portable stair platform 100 low while providing sufficient material strength and considering cost factors.

A second set of legs 130 extends from the second end 112b of the primary member 110. One leg 130 may be adjacent the first side 111a of the primary member 110, and another leg 130 (not shown) may be adjacent the second side 111b of the primary member 110. The legs 130 may be height-adjustable, and as shown in FIGS. 2, 4A, and 4B, the legs 130 may be threaded legs continuously adjustable for a distance that is at least as long as the predetermined increment of adjustability of the legs 120.

FIGS. 5A and 6 show that a pair of wheels 140 may be operatively coupled to the primary member 110 adjacent the first end 112a to transport the primary member 110 when the first set of legs 120 is at the second position 120b. A retractable handle 145 may be operatively coupled to the primary member 110 to guide the primary member 110 as it is moved by the wheels 140.

As shown throughout the drawings, a lip 150 may extend along the first end 112a of the primary member 110 to restrain objects (e.g., ladder 2 shown in FIG. 1) from passing off the first end 112a of the primary member 110 when the first set of legs 120 is at the first position 120a (FIG. 1) and to support objects (e.g., paint cans, boxes, etc.) when the first set of legs 120 is at the second position 120b (FIG. 6). The portable stair platform 100 may be utilized as a hand truck when the first set of legs 120 is at the second position as shown in FIG. 6, and as such, the portable stair platform 100 may be referred to as a combination stair platform and hand truck.

In use, the first set of legs 120 may be placed atop a stair 5, and the second set of legs 130 may be placed atop another stair 5 (FIG. 1). The length of the first set of legs 120 and the second set of legs 130 may be adjusted as described above and shown in FIGS. 4A and 4B. Because the second set of legs 130 may be continuously adjustable, the legs 120, 130 may be collectively adjusted so that the generally planar upper surface 113 is generally horizontal, regardless of the configuration of the stairs 5. A ladder 2 may then be placed atop the upper surface 113 to provide access to areas otherwise unreachable, and the rubberized characteristics of the upper surface 113 and the lip 150 may keep the ladder 2 atop the upper surface 113. To transport the portable stair platform 100, all objects may be removed from atop the upper surface 113, and the first set of legs 130 may be moved from the first position 120a (FIGS. 1 and 2) to the second position 120b (FIGS. 3, 5A, and 6) as discussed above. The extendable handle 115 or the wheels 140 may then be used to move the portable stair platform 100. Objects (e.g., paint cans, boxes, etc.) may be supported by the lip 150 while the portable stair platform 100 is being moved, and as such, the portable stair platform 100 may act as a hand truck.

It is understood that while certain forms of this invention have been illustrated and described, it is not limited thereto except insofar as such limitations are included in the following claims and allowable functional equivalents thereof.

What is claimed is as follows:

1. A portable stair platform, comprising:
a generally planar member having opposed first and second sides and opposed first and second ends;
a first set of legs extending from said first end of said planar member, said first set of legs being movable between a first position generally perpendicular to said planar member and a second position generally parallel to said planar member;
a second set of legs extending from said second end of said planar member; and
wherein at least one of said first set of legs and said second set of legs is height-adjustable.

2. The portable stair platform of claim 1, further comprising a wheel operatively coupled to said planar member for transporting said planar member when said first set of legs is at said second position.

3. The portable stair platform of claim 2, further comprising a retractable handle operatively coupled to said planar member.

4. The portable stair platform of claim 2, further comprising a lip extending along said first end of said planar member to restrain objects from passing off said first end of said planar member when said first set of legs is at said first position and to support objects when said first set of legs is at said second position, whereby said portable stair platform may be utilized as a hand truck when said first set of legs is at said second position.

5. The portable stair platform of claim 4, wherein:
a retractable handle is operatively coupled to said planar member;
said first set of legs includes one leg adjacent said first side of said planar member and one leg adjacent said second side of said planar member;
said second set of legs includes one leg adjacent said first side of said planar member and one leg adjacent said second side of said planar member;
each leg in said first set of legs is a telescoping leg having a predetermined increment of adjustability;
each leg in said second set of legs is a threaded leg continuously adjustable for a distance that is at least as long as said predetermined increment of adjustability;
a pin selectively maintains said first set of legs at said first and second positions;
said planar member has a top portion and a plurality of siderails;
said top portion includes a rubberized material to prevent objects from sliding along said planar member; and
at least one said siderail includes an extendable handle.

6. The portable stair platform of claim 1, wherein:
said first set of legs includes one leg adjacent said first side of said planar member and one leg adjacent said second side of said planar member; and
said second set of legs includes one leg adjacent said first side of said planar member and one leg adjacent said second side of said planar member.

7. The portable stair platform of claim 6, wherein:
each leg in said first set of legs is a telescoping leg having a predetermined increment of adjustability;
each leg in said second set of legs is a threaded leg continuously adjustable for a distance that is at least as long as said predetermined increment of adjustability.

8. The portable stair platform of claim 1, wherein a pin selectively maintains said first set of legs at said first and second positions.

9. The portable stair platform of claim 1, further comprising a lip extending along said first end of said planar member to restrain objects from passing off said first end of said planar member.

10. The portable stair platform of claim 1, wherein:
said planar member has a top portion and a plurality of siderails;
said top portion includes a rubberized material to prevent objects from sliding along said planar member; and
at least one said siderail includes an extendable handle.

11. The portable stair platform of claim 1, wherein said first set of legs are legs constructed of aluminum channel.

12. A portable stair platform, comprising:
a primary member having opposed first and second sides, opposed first and second ends, and a generally planar upper surface;
a first set of legs extending from said first end of said primary member, said first set of legs being movable between a first position generally perpendicular to said upper surface of said primary member and a second position generally parallel to said upper surface of said primary member;
a second set of legs extending from said second end of said primary member; and
wherein at least one of said first set of legs and said second set of legs is height-adjustable.

13. The portable stair platform of claim 12, further comprising a wheel operatively coupled to said primary member for transporting said primary member when said first set of legs is at said second position.

14. The portable stair platform of claim 13, further comprising a retractable handle operatively coupled to said primary member.

15. The portable stair platform of claim 13, further comprising a lip extending along said first end of said primary member to restrain objects from passing off said first end of said primary member when said first set of legs is at said first position and to support objects when said first set of legs is at said second position, whereby said portable stair platform may be utilized as a hand truck when said first set of legs is at said second position.

16. The portable stair platform of claim 12, wherein:
said primary member includes a plurality of siderails supporting said generally planar upper surface; and
said generally planar upper surface includes a rubberized material to prevent objects from sliding along said generally planar upper surface.

17. The portable stair platform of claim 16, wherein said generally planar upper surface includes plywood and said siderails are constructed of aluminum channel.

18. The portable stair platform of claim 12, wherein:
said first set of legs includes one leg adjacent said first side of said primary member and one leg adjacent said second side of said primary member;
said second set of legs includes one leg adjacent said first side of said primary member and one leg adjacent said second side of said primary member;
each leg in said first set of legs is a telescoping leg having a predetermined increment of adjustability;
each leg in said second set of legs is a threaded leg continuously adjustable for a distance that is at least as long as said predetermined increment of adjustability.

19. A combination stair platform and hand truck, comprising:
a generally planar member having opposed first and second sides and opposed first and second ends;
a first set of legs extending from said first end of said planar member, said first set of legs being movable between a first position generally perpendicular to said planar member and a second position generally parallel to said planar member;
a second set of legs extending from said second end of said planar member;
a pair of wheels operatively coupled to said planar member adjacent said first end to transport said planar member when said first set of legs is at said second position;
a lip extending along said first end of said planar member to restrain objects from passing off said first end of said planar member when said first set of legs is at said first position and to support objects when said first set of legs is at said second position;
wherein at least one of said first set of legs and said second set of legs is height-adjustable.

20. The combination stair platform and hand truck of claim 19, wherein:
a retractable handle is operatively coupled to said planar member;
said first set of legs includes one leg adjacent said first side of said planar member and one leg adjacent said second side of said planar member;
said second set of legs includes one leg adjacent said first side of said planar member and one leg adjacent said second side of said planar member;
each leg in said first set of legs is a telescoping leg having a predetermined increment of adjustability;
each leg in said second set of legs is a threaded leg continuously adjustable for a distance that is at least as long as said predetermined increment of adjustability;
a pin selectively maintains said first set of legs at said first and second positions;
said planar member has a top portion and a plurality of siderails;
said top portion includes a rubberized material to prevent objects from sliding along said planar member; and
at least one said siderail includes an extendable handle.
